(19) United States
(12) Patent Application Publication
(10) Pub. No.: US 2014/0222831 A1
(43) Pub. Date: Aug. 7, 2014

(54) METHOD AND SYSTEM FOR PERSONALIZED DELIVERY OF MEDIA CONTENT

(71) Applicants: Gurumurthy D. Ramkumar, Palo Alto, CA (US); Dominic Hughes, Menlo Park, CA (US); Keshav Menon, Sunnyvale, CA (US); Joseph Huang, San Francisco, CA (US); Georgios Sofianatos, San Francisco, CA (US)

(72) Inventors: Gurumurthy D. Ramkumar, Palo Alto, CA (US); Dominic Hughes, Menlo Park, CA (US); Keshav Menon, Sunnyvale, CA (US); Joseph Huang, San Francisco, CA (US); Georgios Sofianatos, San Francisco, CA (US)

(21) Appl. No.: 13/761,420

(22) Filed: Feb. 7, 2013

(51) Int. Cl. G06F 17/30

(52) U.S. Cl. CPC G06F 17/30861
USPC 707/748

(57) ABSTRACT

In one exemplary embodiment, a system includes a social media tag-cloud generator. The social media tag-cloud generator obtains a user's social media feed and generates a topic tag cloud. The topic tag cloud includes a weighted key term representing a topic that occurs in the user's social media feed. A media-content source module obtains a first metadata about a first media-content episode. The media-content source module obtains a second metadata about a second media-content episode. The first metadata includes information to identify the first media content episode and to locate the first media content episode in a computer network. The second metadata includes information to identify the second media content episode and to locate the second media content episode in the computer network. A media-content scoring module determines a first score for the first media-content episode. The first score includes a first value judgment based on the weighted key term.

### CROSS-REFERENCE TO RELATED APPLICATIONS

This application is a claims priority to U.S. patent provisional application No. 61/716,540 titled SYSTEM AND METHOD FOR PERSONALIZED DELIVERY OF MEDIA and filed on Oct. 21, 2012. This provisional application is hereby incorporated by reference in its entirety.

### BACKGROUND

1. Field

This application relates generally to media content, and more specifically to a system and method for personalized delivery of media content.

2. Related Art

Conventional methods of delivering media for individuals may require substantial user effort to identify potential media content and/or to select media content to access. For example, a user may be required to perform a plurality of searches of the Internet to locate media of interest. Accordingly, improvements may be made over conventional methods of selecting or delivering media.

### BRIEF SUMMARY OF THE INVENTION

In one aspect, a system includes a social media tag-cloud generator. The social media tag-cloud generator obtains a user's social media feed and generates a topic tag cloud. The topic tag cloud includes a weighted key term representing a topic that occurs in the user's social media feed. A media-content source module obtains a first metadata about a first media-content episode. The media-content source module obtains a second metadata about a second media-content episode. The first metadata includes information to identify the first media content episode and to locate the first media content episode in a computer network. The second metadata includes information to identify the second media content episode and to locate the second media content episode in the computer network. A media-content scoring module determines a first score for the first media-content episode. The first score includes a first value judgment based on the weighted key term. A second score is determined for the second media-content episode. The second score includes a second value judgment based on the weighted key term. A sorted list is generated based on the first score and the second score. The sorted list includes the first metadata about the first media content episode and the second metadata about a second media-content episode. A client management module provides the sorted list to a client media-content application operating in a user's computing device. A user's skip/consume behavior information with respect to the first media-content episode and the second media-content episode is received from the client media-content application.

Optionally, the first value judgment can be based on the weighted key term, the first weighted average judgment based on the user's skip/consume behavior information with respect to the first media content episode, a first prior by curator score of a first program of the first media content, a first episode delta score of the first media content, and a first user peer score of the first program. The second value judgment can be based on the weighted key term, the second weighted average judgment based on the user's skip/consume behavior information with respect to the second media content episode, a second prior by curator score of a second program of the second media content, a second episode delta score of the second media content, and a second user peer score of the second program. The user's social media feed comprises a social networking service microblog feed managed by the user.

In another aspect, a method includes the step of receiving a user's skip/consume behavior data with respect to a set of consumed media-content episodes. The user's skip/consume behavior data is received from a client media-content application in a user's mobile device. A media-content episode is associated with a media-content program and a media-content topic. A set of unconsumed media content episodes is received. A set of media-content programs and a set of media-content topics associated with the set of consumed media-content episodes are scored, with at least one processor, based on the user's skip/consume behavior data with respect each member of the set of consumed media-content episodes. The set of unconsumed media-content episodes is sorted according to a score of the set of media-content programs and the set of media-content topics.

### BRIEF DESCRIPTION OF THE DRAWINGS

The present application can be best understood by reference to the following description taken in conjunction with the accompanying figures, in which like parts may be referred to by like numerals.

FIG. 1 depicts, in block diagram format, an example system for personalized delivery of media content, according to some embodiments.

FIG. 2 depicts, in block diagram format, an example content scoring module, according to some embodiments.

FIG. 3 illustrates an example system for generating a topic tag cloud, according to some embodiments.

FIG. 4 depicts an example of a system and process for scoring a media content episode, according to some embodiments.

FIG. 5 illustrates an example of a sorted media content playlist, according to some embodiments.

FIGS. 6 A-B depict example graphical representations of various judgment functions, according to some embodiments.

FIG. 7 illustrates an example of a process for calculating an episode delta average for a particular episode of media content, according to some embodiments.

A graphical example of an implementation of a user peer value function is provided in FIG. 8, according to some embodiments.

FIG. 9 illustrates an example of a mobile device displaying a sorted content media application interface, according to some embodiments.

FIG. 10 depicts an exemplary computing system that can be configured to perform the processes provided herein.

FIG. 11 illustrates an example process for personalized delivery of media content, according to some embodiments.

FIG. 12 illustrates another example process for personalized delivery of media content, according to some embodiments.

The Figures described above are a representative set, and are not an exhaustive with respect to embodying the invention.

### DETAILED DESCRIPTION

Disclosed are a system, method, and article of manufacture of personalized delivery of media content. Although the present embodiments included have been described with reference to specific example embodiments, it can be evident that various modifications and changes may be made to these embodiments without departing from the broader spirit and scope of the particular example embodiment.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

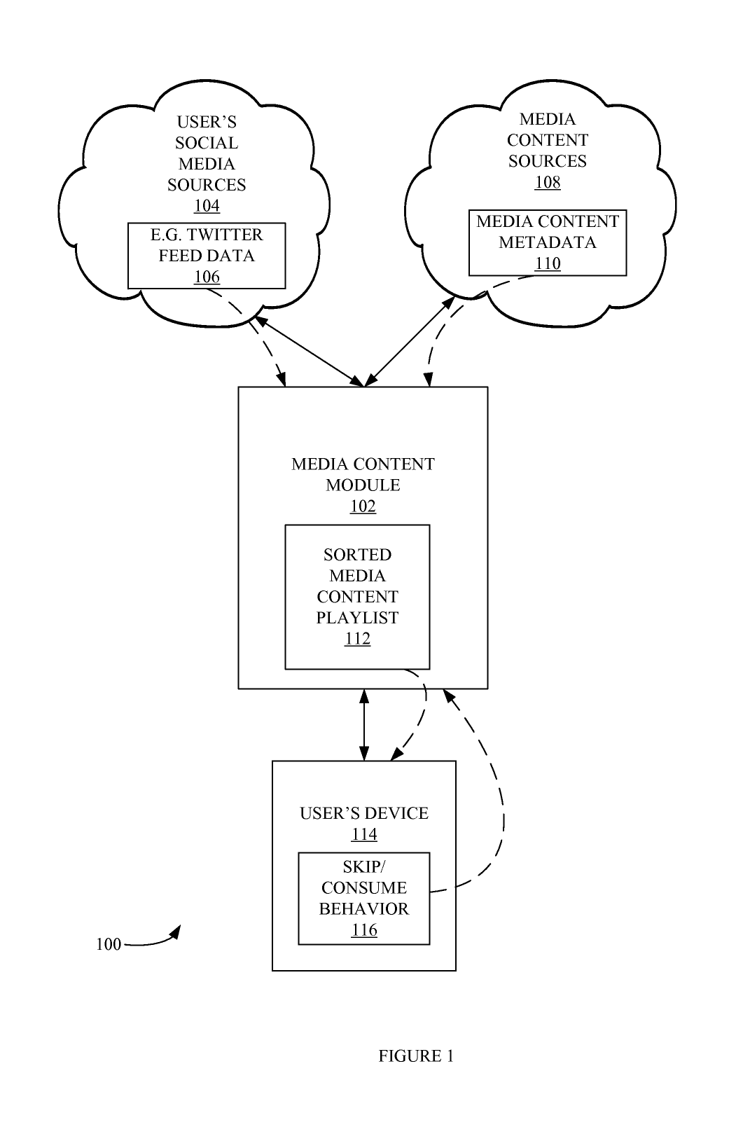

FIG. 1 depicts, in block diagram format, an example system 100 for personalized delivery of media content, according to some embodiments. System 100 includes media content module 102. Media content module 102 can obtain input data from various sources such as user's social media sources 104, media content sources 108 and a user's computing device 114. Media content module 102 can utilize input data to score and/or rank media content based on various factors such as a user's social media content feed (e.g. Twitter® or Facebook® (and/or other social network) feed content 106 and/or hyperlinked content therein, and users or topics followed therein), a user's skip/consume behavior 116 with respect to already provided media content, and the like. It is noted that media content module 102 may not necessarily store the media content itself. Rather, media content module 102 can obtain and media content metadata 110 (e.g. a pointer data to media content sources) in a sorted media content playlist 112.

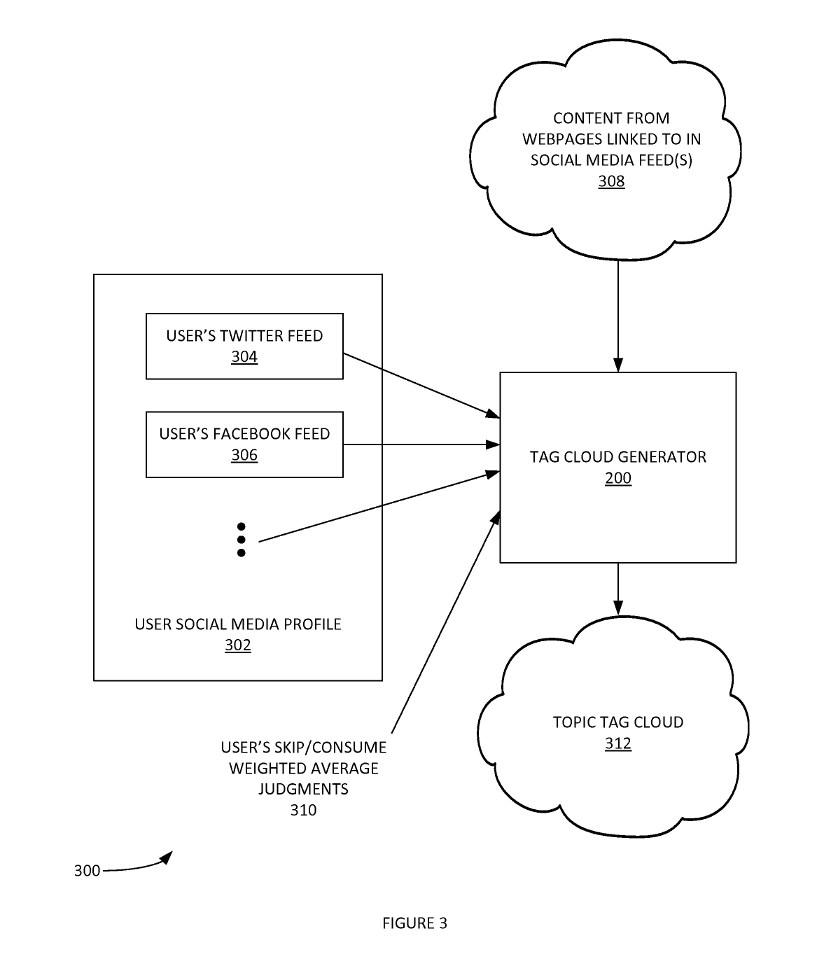

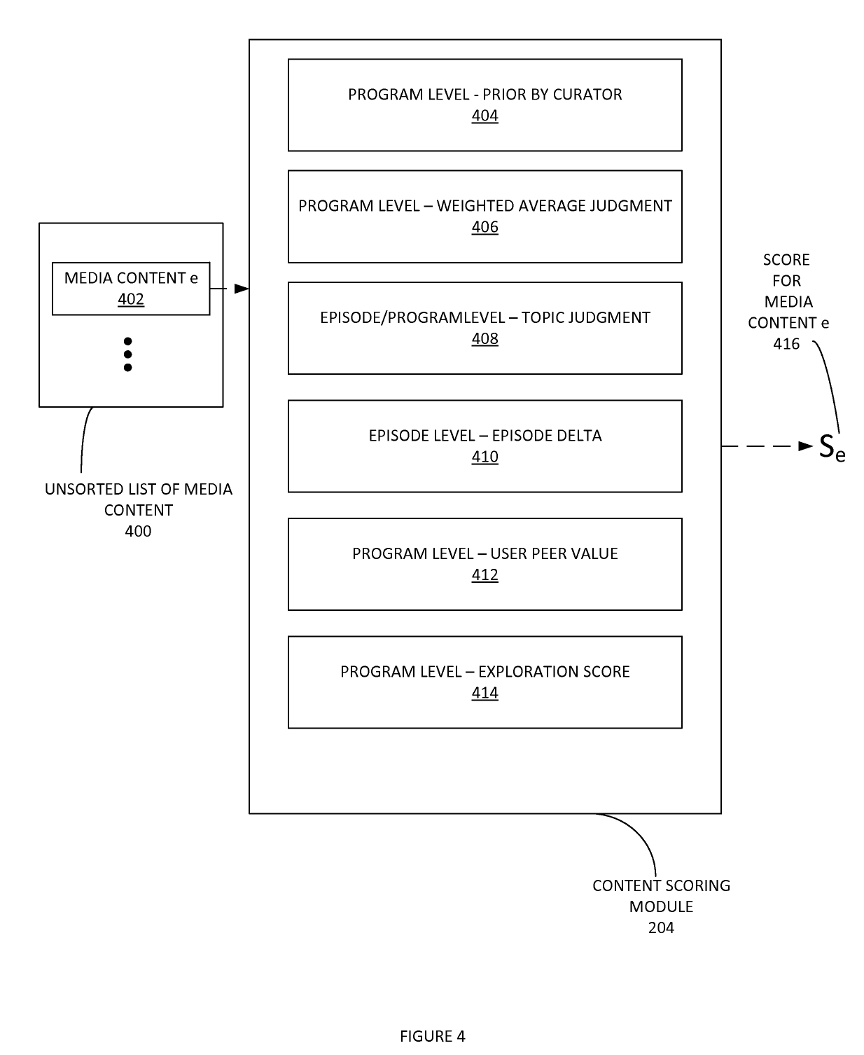

A user's social media content feed can be utilized to determine topics of interest to the user. These topics can be weighted based on such factors as the frequency of appearance of hyperlinks to documents about the topic in a social media feed, analysis of the documents themselves, and the like. In some embodiments, a topic tag cloud can be generated that includes the weighted topics. The topic tag cloud can be utilized to score media content and/or sort media content playlist 112 (e.g. see FIG. 3 and FIG. 4 infra). Additionally, a user's skip/consume behavior 116 with respect to already provided media content can be obtained by media content module 102. User's skip/consume behavior 116 can be analyzed to further score media content and sort media content playlist 112 (e.g. by calculating weighted judgments from the user's skip/consume actions). In this way, media content playlist 112 can be dynamically generated and/or sorted with media content the user is more likely to consume to completion appearing before media content the user is less likely to consume to completion.

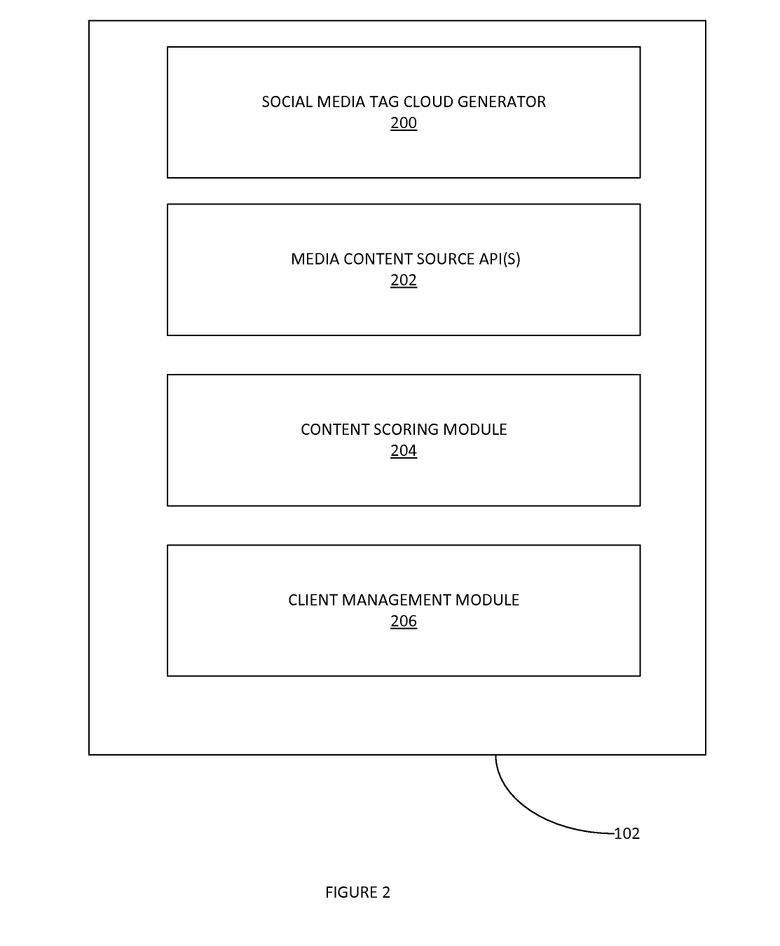

FIG. 2 depicts, in block diagram format, an example media content module 102, according to some embodiments. Media content module 102 can include various modules for obtaining information about a user (e.g. a user's social media data, user's skip/consume behavior with respect to media content, and the like) and generate a sorted media content playlist. For example, Media content module 102 can include a social media tag cloud generator 200. Social media tag cloud generator 200 can obtain a user's social media feeds can generate a topic tag cloud (e.g. a weighted list). The topic tag cloud can include key terms (e.g. tags) representing topics that occur in the user's social media feed. For example, documents referenced by hyperlinks in a user's Twitter® or Facebook® feed can be searched and analyzed. Topics occurring in these documents can be scored (e.g. based on various factors such as frequency of occurrence, commonality of occurrence, and/or relative importance). Tags can be associated with each topic. These tags can then be included in the topic tag cloud and the relative prominence (e.g. weight) of the tag can be determined according to the associated topic's score. Additional examples of generating a tag cloud are provided herein.

Media content source application programming interface(s) (APIs) 202 can be utilized to obtain metadata about available media content to be included in a sorted media content playlist. Example media content sources can include news and information audio/video sources (e.g. NPR®, audio/visual weblogs, podcasts, online educational content (e.g. iTunes® university and the like), traffic reports, weather reports, local news content, etc.). Content metadata can include information used to identify and/or locate the media content to be listed and/or ranked. Content metadata can include, inter alia, media content titles, media content type, topic of content media, episode designation(s), program designation(s), origin information, a reference to the full version, media content location (e.g. a uniform resource locator (URL)), a computer generated transcript of the content, and the like.

Content scoring module 204 can score each incoming media-content episode. Based on these scores, content scoring module 204 can sort a media content playlist and provide the media content playlist to a user's client media content application. Content scoring module 204 can dynamically update and/or re-sort the media content playlist based on input data (e.g. user skip/consume data, social media feed data, etc.). An example of a content scoring module 204 is provided in FIG. 4 infra. Examples of content scoring methods and processes are provided, inter alia, in FIGS. 4-12.

Client management module 206 can serve a client media-content application operating in a user's computing device. For example, client management module 206 can provide media content playlists and concomitant metadata (e.g. links to media content and the like) to the client media content application. Client management module 206 can obtain data from the client media-content application as well. For example, client management module 206 can obtain user behavior data with respect to the media content playlist such as, inter alia, a user's skip/consume data and timestamps that indicate amount of time a user consumed a particular media content, etc. A skip can be an operation to pass over and/or omit the remainder of a media-content episode. As shown, example content scoring module 204 can continuously evaluate and dynamically update sorted content media playlists based on input information.

FIG. 3 illustrates an example system 300 for generating a topic tag cloud 302, according to some embodiments. System 300 can include a user's social media profile 302. Social media profile 302 can include a user's various social media feeds (e.g. Twitter® feeds, Facebook® feeds, etc.). Hyperlinks in the users' social media feeds can be followed automatically by the system to the referenced articles/documents. The content of the articles/documents can be analyzed to create a social media feed tag cloud (e.g. a Twitter® tag cloud, a Facebook® tag cloud, etc.). Each topic (e.g. science, business, technology, news, and the like) can have its own tag cloud. A user's topic tag cloud 312 can be determined by intersecting the tag cloud for each topic (e.g. a science tag cloud) with the user's respective social media feed tag clouds. A weight for each topic can be determined accordingly and the user topic tag cloud 312 generated. In some embodiments, the user's topic tag cloud 312 can also be influenced by a user's skip/consume behavior as well. For example, in one embodiment, a topic weight can equal topic's tag cloud value times a social media feeds tag cloud value for the topic plus a user's skip/consume weighted judgment for the topic.

FIG. 4 depicts an example of a system and process for scoring a media content episode (e.g. media content ‘e’ 402), according to some embodiments. Media content ‘e’ 402 can be included in an unsorted list of media content episodes derived from various media content sources. It is also noted that the media content itself may not be included in the playlist, but rather media content metadata (e.g. pointers and other relevant information about the media content such as program topic, episode topic, origin, location, time stamp, etc.). It is further noted that the unsorted list 400 may have been previously sorted but subjected to a re-sorting operation in order to update its order based on recently acquired input parameters (e.g. an updated topic tag cloud, updated user skip/consume data, and the like).

Modules 404-414 can analyze program and/or episode level information about media content ‘e’ 402 and generate a score for media content ‘e’ 416 (e.g. as represented by ‘Sₑ’) with respect to a particular user. In this way, modules 404-414 can each provide an independent orthogonal component of the final score ‘Sₑ’. Each media content member of unsorted list 400 can be scored in turn. The process can be repeated at specified periodic intervals and/or upon certain specified system triggers. At the program level, prior by curator module 404 can provide a score previously assigned by a system administrator to media content ‘e’ 402.

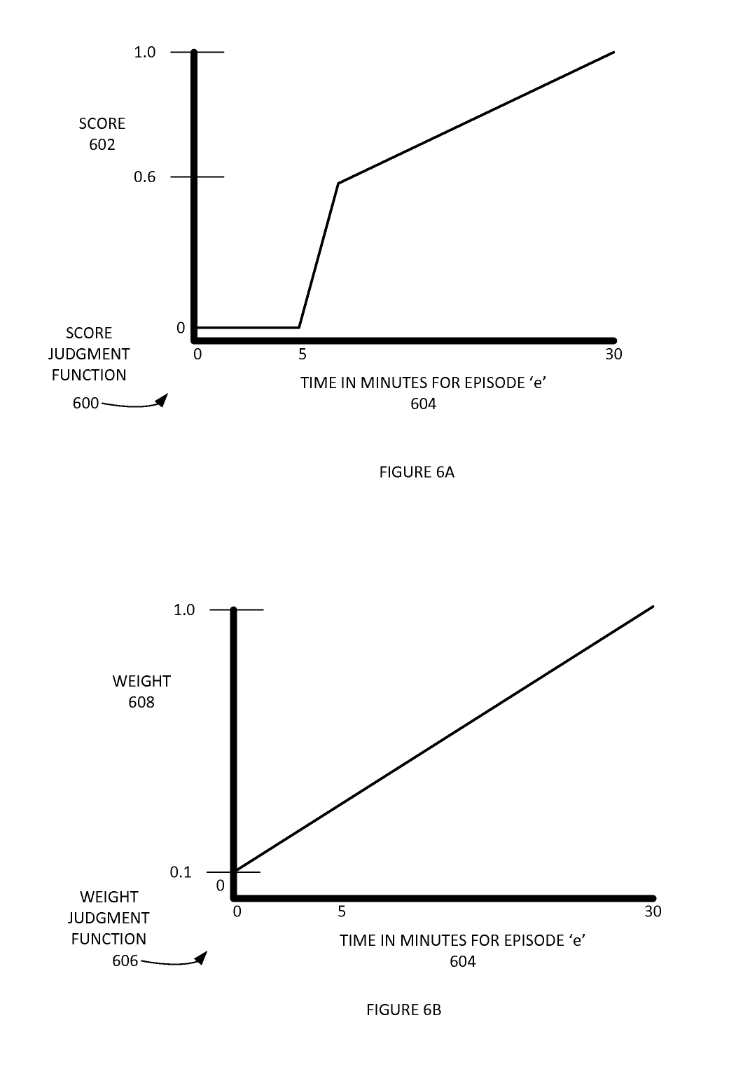

At both the program and episode levels, weighted average judgment module 406 can assigned a scored to be factored into Sₑ based on weighted average judgments determined by the user's previous skip/consume behavior with respect to media content the user has previously experienced. Examples of components of a weighted average judgment functions are provided in FIGS. 6 A-B.

At the episode and/or program level, topic judgment module 408 can assign a topic score to be factored into Sₑ. A topic score for a particular episode and/or program can be determined based on the weight of the respective topics of the user's current topic tag cloud 312. For example, the ‘science’ topic can be weighted greater than the ‘business’ topic in the user's current topic tag cloud 312. Topic judgment module 408 can then assign media content associated with topic ‘science’ higher than media content associated with topic ‘business’.

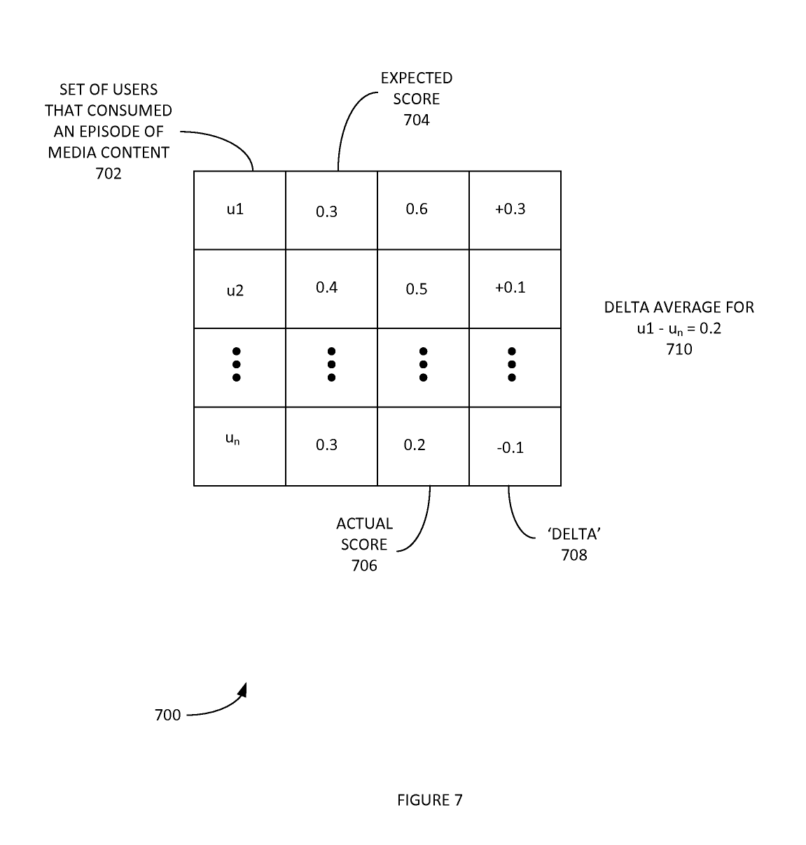

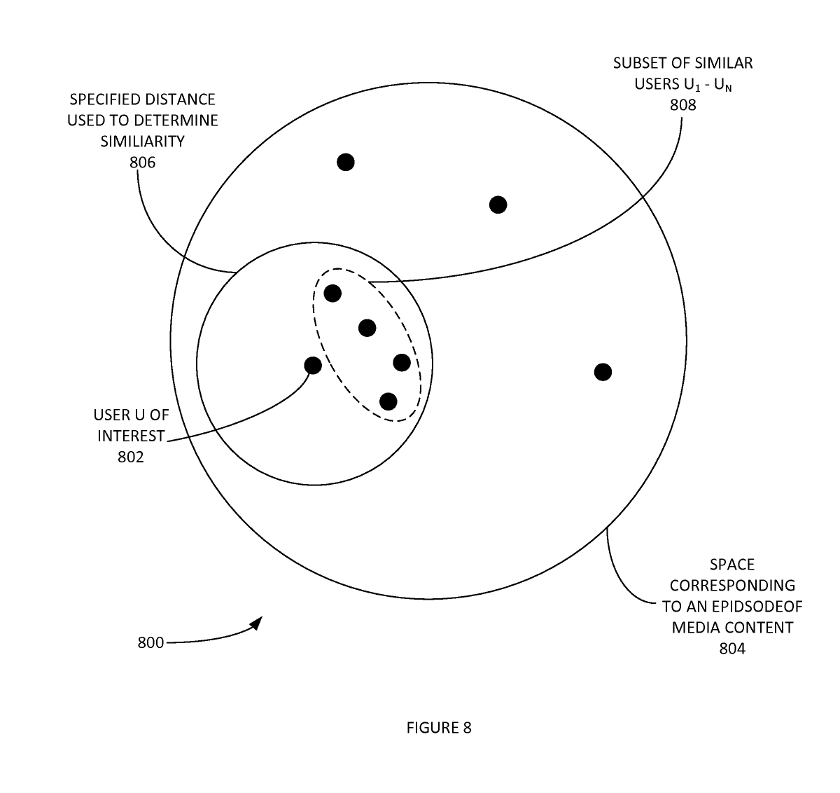

At the episode level, episode delta module 410 can provide a score to be factored into Sₑ based on a collaborative filtering process. For example, a set of users can consume a particular episode of a podcast. An expected score (e.g. an expected weighted average judgment) can be generated for each user (e.g. using each user's historical consumption data). Expected score is an average of judgments of the user for that program, weighted by time decay, and judgments of other users. As each user consumes the episode, an actual score (e.g. an actual weighted average judgment) can be generated based on the user's behavior. The difference (e.g. the ‘delta’) between the expected and actual score can be determined for each user. These scores can be averaged to determine the ‘episode delta’ score for the episode. Media content episodes with higher episode delta values can be ‘pushed higher’ in a user's sorted media playlist. In this way, a user can be exposed to media content that her peers found interesting. An example of an episode delta process is provided in FIG. 7, infra.

At the program level, user peer value module 412 can apply a collaborative filtering algorithm with a similarity of users aspect to further influence the value of score Sₑ. For example user peer value module 412 can provide a user peer score. User peer score can be factored into Sₑ. In one example, a peer subset of users U₁-U_{N} can be determined to be similar to a particular user U. For example, users U₁-U_{N} can have made similar judgments with respect to various media content as user U. Once a peer subset is determined, a media content program P that the peer subset favored (e.g. based on their weighted average judgments as derived from skip/consume behavior with respect to episode(s) of program Ps) can receive a higher user peer score when presented to user U′s content scoring module than media content the peer subset did not favor. In one example, a user peer score can be the average judgment of users U₁-U_{N} for a program P.

An example of determining peer subset U₁-U_{N} is now provided. The users of system 100 can be mapped in an n-dimensional space. Each dimension of the n-dimensional space can correspond to a media content episode and/or program. The location of each user in the n-dimensional space can be based on their previous respective judgments (e.g. weighted average judgments derived from skip/consume behavior) with respect to the media content episode and/or program of each dimension. For user U, the peer subset of other users U₁-U_{N} can be determined based on their respective distance from user in the n-dimensional space. This can be determined utilizing a judgment distance function. For example, the distance from the user can be calculated from the dot product of the user's weighted average judgments with every other user. Other users found to be within a specified distance from user U can be included within the peer subset. A graphical example of a user peer value function is provided in FIG. 8, infra.

At the program level, an exploration score module 414 can increase the score Sₑ of randomly and/or system administrator selected media content. In some embodiments, exploration score module 414 can be optional. An exploration score can be applied to media content programs that a user has not yet heard. In this way, exploration score module 414 can be utilized to prevent a user from being ‘trapped’ inside a narrow set of media content topics.

It is noted that, in some embodiments, one or more modules 404-414 can be omitted according to a system administrator preference. Additionally, a system administrator can tune score Sₑ in various ways. For example, the respective scores of modules 404-414 can each be weighted to increase or decrease their influence on Sₑ.

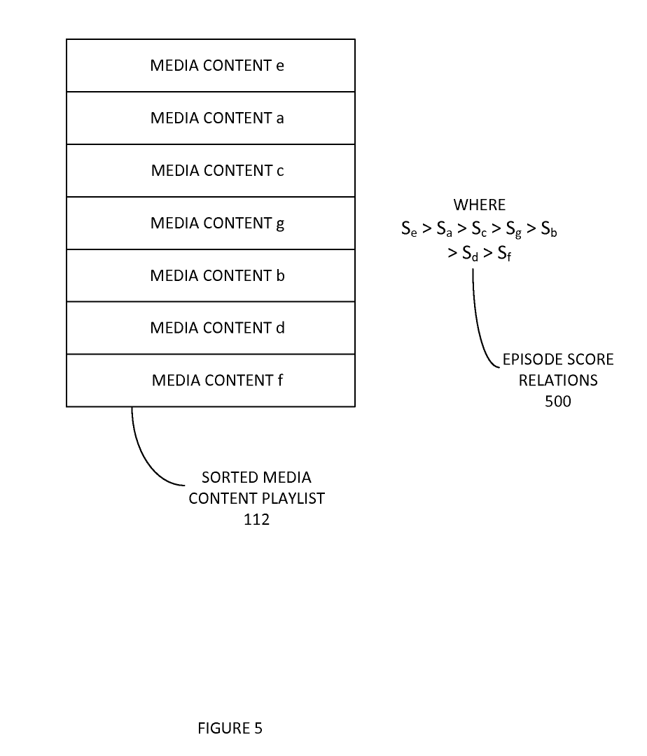

FIG. 5 illustrates an example of a sorted media content playlist 112, according to some embodiments. Sorted media content playlist 112 can include media content A-G. Each media content has been scored by client scoring module 204 where S_{c}>Sₐ>S_{c}>S_{g}>S_{b}>S_{d}>S_{f} (‘Sₙ’ representing the score of each media content). The media content is then sorted according to score with media content the user is more likely to hear to completion appearing before media content the user is less likely to hear to completion. It is noted that each score is specific to a particular user. Thus, a particular media content can have n-number of scores when there are n-number of associated users. It is also noted that the media content itself may not be included in the playlist. Rather, pointers and other metadata that enable a client media-content application in a user's computing device to locate and play the media can be provided. Each media content A-G represents an episode and/or other serial element of a media content.

FIGS. 6A-B depicts example graphical representations of various judgment functions that can be utilized to generated a weighted average judgment score for a user with respect to a media content program, according to some embodiments.

As used herein, a program can be a production of at least one or more episodes (e.g. a serialized television, podcast and/or radio program). An episode can be a unit of a serialized program. However, an episode can also be a single audio and/or video production (or even an image in some embodiments), and need not be a unit of a serialized program (e.g. a single recording of a famous speech and/or other event). Examples of programs include Talk of the Nation®, Fresh Air®, the News Hour®, This American Life® and the like.

FIG. 6A depicts a graphical representation of an example score judgment function 600, according to some embodiments. Score judgment function 600 can relate a score 602 with the time a user consumed a particular episode of media content (in this example media content ‘e’). In this way, score 602 can vary as a function of time. For example, score can increase from a minimum of zero (0) to one (1) for the period of an associated media-content episode. The entire period of media content ‘e’ can be thirty (30) minutes. Score judgment function 600 can be algorithmically preset for each episode of media content. In this particular example, score 602 have a value of zero for the first five (5) minutes. At five minutes, score 602 can begin to increase at a specified slope to a value of 0.6 at which point the slope again increases until a score of one is reached at thirty minutes. In this way, if a user skips past media content episode ‘e’ before five minutes, the score is zero. If the user consumes all thirty minutes of media content episode ‘e’, the score is one. It is noted that score judgment function 600 is provided for exemplary purposes and other score judgment functions can be utilized in various other embodiments.

FIG. 6B depicts a graphical representation of an example weight judgment function 606, according to some embodiments. The weight 608 value varies from 0.1 to one and relates to the amount of time the user consumes media content episode ‘e’. In this particular example, weight value 608 can increase with a constant slope. It is noted that weight judgment function 606 is provided for exemplary purposes and other weight judgment functions can be utilized in various other embodiments.

Score 602 can indicate a user's level of interest in the episode. This can also imply an interest in a serialized program of which the episode is a part. Weight value 608 can indicate the weight the score judgment carries. A weighted average judgment can be calculated from score 602 and weight value 608 (e.g. by weighted average judgment module 406). The weight is higher if the user consumes content for longer and lower otherwise. Thus, the longer a user consumes an episode the greater the score can grow and the greater the weight that score can have in the scoring of other media content episodes in the same program by content scoring module 204 (e.g. the greater the influence on the score Sₑ by weighted average judgment 406).

FIG. 7 illustrates an example of a process 700 for calculating an episode delta average 710 for a particular episode of media content, according to some embodiments. Episodes delta average 710 can be calculated from scoring user behavior patterns of a set of users (U₁-Uₙ) 702 that consumed (e.g. listened to, watched, viewed) an episode of media content. An expected score 704 can be calculated for each user with respect to a media-content episode. Expected score 704 can be determined utilizing various methodologies such as an expected weighted average of a predicted user judgment based, inter alia, on the user's historical behavior patterns. After the user has consumed the media content an actual score 706 can be calculated (e.g. the actual weighted average judgment for the user). The difference (e.g. a ‘delta’ 708) between the expected and actual score can be determined for each user. These scores can be averaged (e.g. a weighted average) to determine the delta average 710 for the episode. For example, a set of users can consume a particular episode of Fresh Air®. An expected score for each of the users with respect to the Fresh Air® episode can be calculated. An actual score for each of the users can be determined after they have consumed a Fresh Air® episode. If the actual score is greater than the expected score, the content scoring module 204 can adjust the score of Fresh Air® episode upwards by a specified amount. In this way, for example, a user consuming her media content playlist at nine in the morning can benefit from previous judgments made by other users earlier in the morning that ‘pushed up’ popular Fresh Air® episode in the user's playlist. It is noted that the particular values depicted in FIG. 7 are for exemplary purposes only and other embodiments are not limited thereby.

A graphical example 800 of an implementation of a user peer value function is provided in FIG. 8, according to some embodiments. A content scoring module can be scoring media content for user of interest 802. Example 800 depicts a mapping of all users of a particular media content system mapped in a space 804 corresponding to a media content episode and/or program. The user's behavior with respect to the media content episode and/or program (e.g. based on their weighted average judgments as derived from skip/consume behavior) can determine the user's location in the space 804. Users are represented in example 800 by black dots.

Nearby users can be formed into peer subset of users U₁-U_{N} 808. For example, users U₁-U_{N} 808 can have made similar judgments with respect to various media content as user U in the past. Users U₁-U_{N} 808 can be determined according to their distance from user U 802. For example, the distance from the user can be calculated from the dot product of the user's weighted average judgments with every other user. The circle 806 graphically represents a specified distance used to determined similarity (e.g. with a specified threshold value according to a judgment distance function). Once a peer subset is determined, media content that users U₁-U_{N} 808 favored (e.g. with weighted average judgments as derived from skip/consume behavior above a specified value) can receive a higher score when presented to user U's content scoring module than media content the peer subset did not favor. For example, example 800 can be used to generate a user peer score. In this way, users U₁-U_{N} 808 consume the Marketplace® program. Users U₁-U_{N} 808 are also determined to be sufficiently similar to user U. User U's content scoring module can then score episodes of Marketplace® higher even if user U has not yet been exposed to Marketplace®.

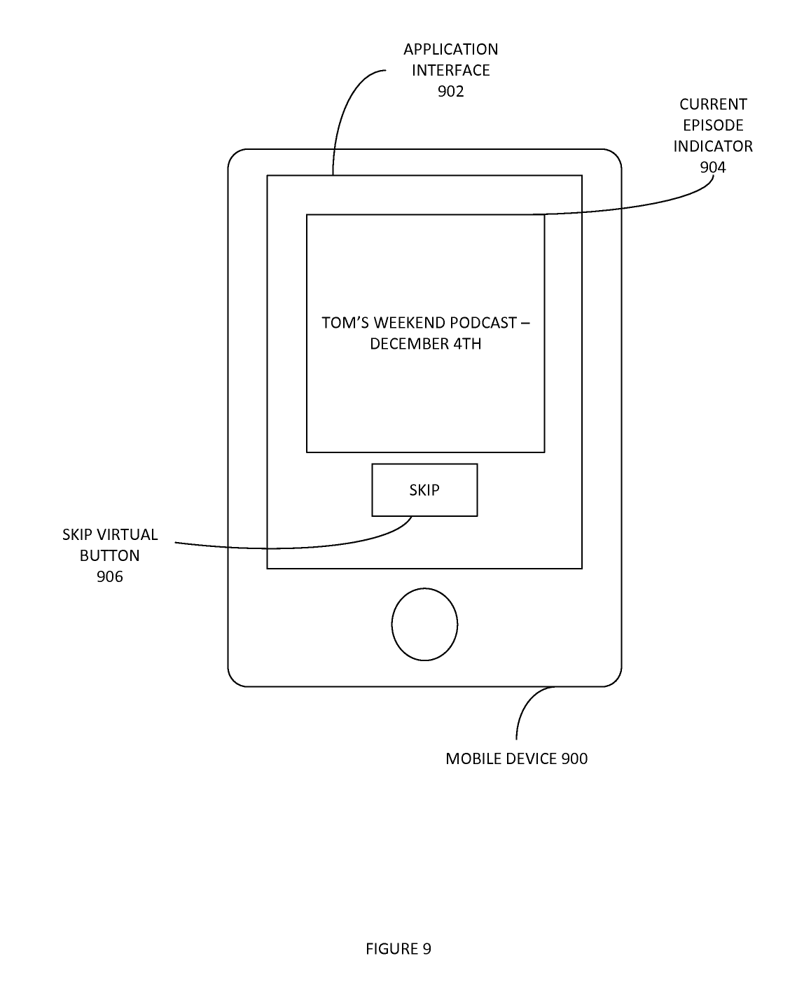

FIG. 9 illustrates an example of a mobile device 900 displaying a sorted content media application interface 902, according to some embodiments. Content media application can be a client application of a personalized content media provider (e.g. operating on a server(s) and/or in a cloud-computing environment). Interface 902 can indicate a current episode with a current episode indicator 904 element. Current episode indicator 904 can provide graphical and/or text information about the current episode being played. In some examples, current episode indicator 904 can further provide additional elements such as hyperlinks to media content original providers and/or additional information about the current media-content episode. A user can skip the remaining media content episode by touching the virtual skip button 906. A next media content episode in a playlist associated with the user can then be played. Information about the next media content episode can be provided in interface 902. User skip information and length of time user consumed an episode can be provided to a system server. The system server can utilize this information to score media content in the user's playlist and subsequently re-sort the playlist as well as include new media content.

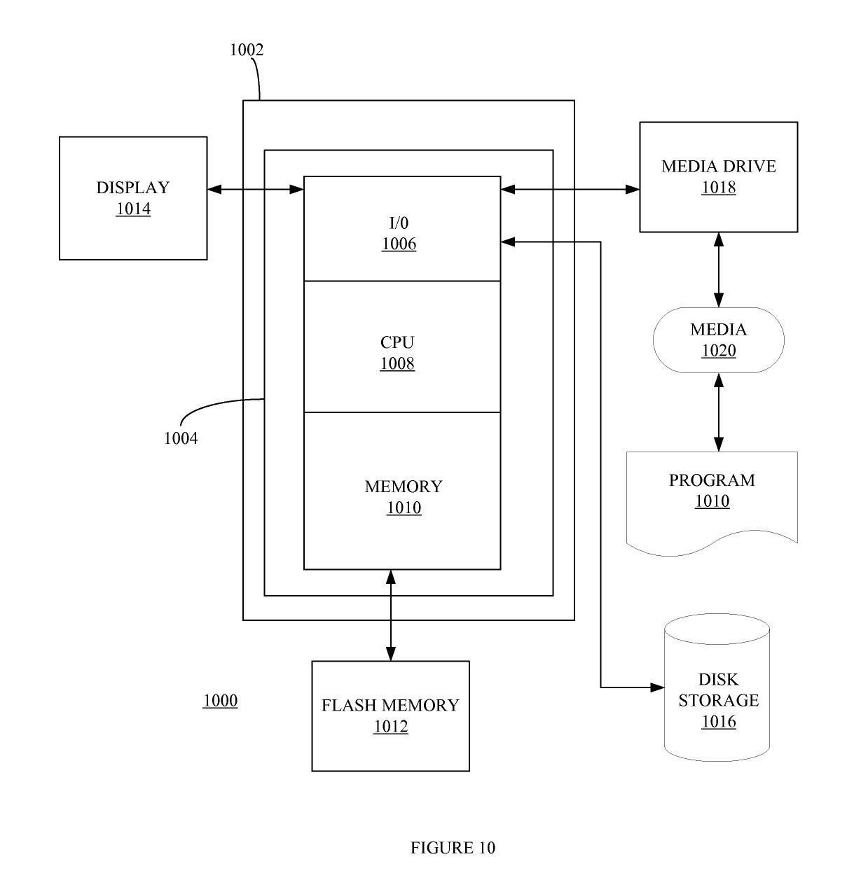

FIG. 10 depicts an exemplary computing system 1000 that can be configured to perform several of the processes provided herein. In this context, computing system 1000 can include, for example, a processor, memory, storage, and I/O devices (e.g., monitor, keyboard, disk drive, Internet connection, etc.). However, computing system 1000 can include circuitry or other specialized hardware for carrying out some or all aspects of the processes. In some operational settings, computing system 1000 can be configured as a system that includes one or more units, each of which is configured to carry out some aspects of the processes either in software, hardware, or some combination thereof.

FIG. 10 depicts a computing system 1000 with a number of components that can be used to perform any of the processes described herein. The main system 1002 includes a motherboard 1004 having an I/O section 1006, one or more central processing units (CPU) 1008, and a memory section 1010, which can have a flash memory card 1012 related to it. The I/O section 1006 can be connected to a display 1014, a keyboard and/or other attendee input (not shown), a disk storage unit 1016, and a media drive unit 1018. The media drive unit 1018 can read/write a computer-readable medium 1020, which can include programs 1022 and/or data. Computing system 1000 can include a web browser. Moreover, it is noted that computing system 1000 can be configured to include additional systems in order to fulfill various functionalities. Display 1014 can include a touch-screen system. In some embodiments, system 1000 can be included in and/or be utilized by the various systems and/or methods described herein. As used herein, a value judgment can refer to a judgment based upon a particular set of values or on a particular value system.

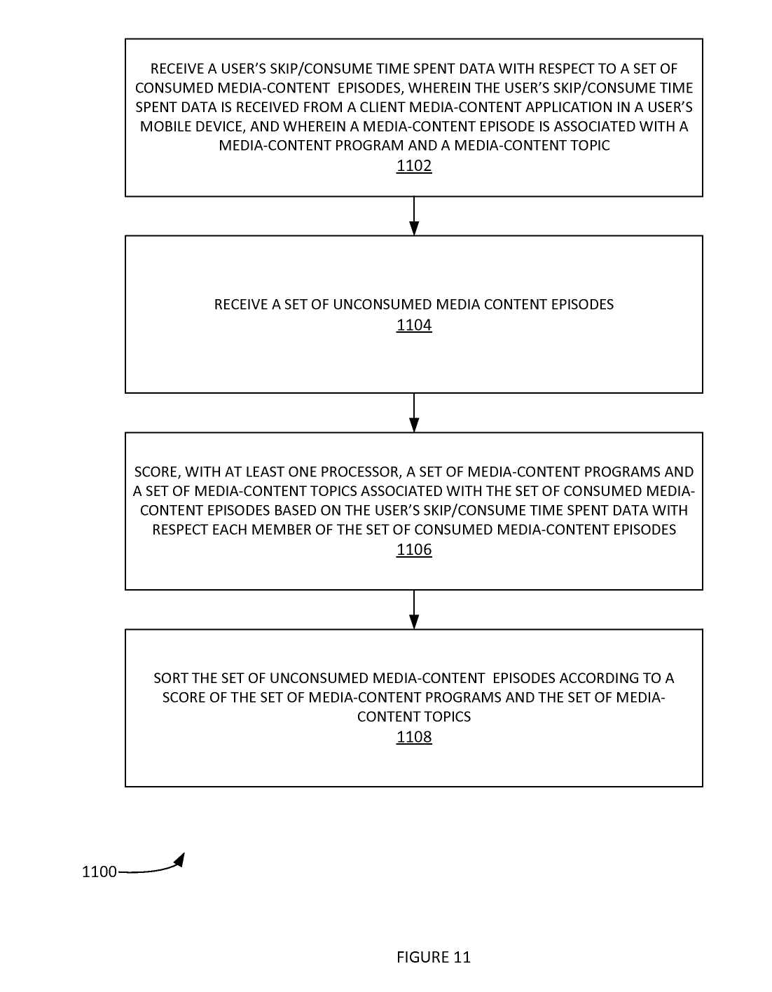

FIG. 11 illustrates an example process 1100 for personalized delivery of media content, according to some embodiments. In step 1102 of process 1100, a user's skip/consume time spent data with respect to a set of consumed media-content episodes can be received. The user's skip/consume time spent data can be received from a client media-content application in a user's mobile device. A media-content episode can be associated with a media-content program and a media-content topic. The user's skip/consume time spent data comprises a time a user consumed each member of the set of consumed media-content episodes relative to each member's total time (see for example FIGS. 6A-B). In step 1104, a set of unconsumed media content episodes is received. In step 1106, a set of media-content programs and a set of media-content topics associated with the set of consumed media-content episodes is scored based on the user's skip/consume time spent data. The scoring can be with respect to each member of the set of consumed media-content episodes. In step 1108, the set of unconsumed media-content episodes is sorted according to a score of the set of media-content programs and the set of media-content topics.

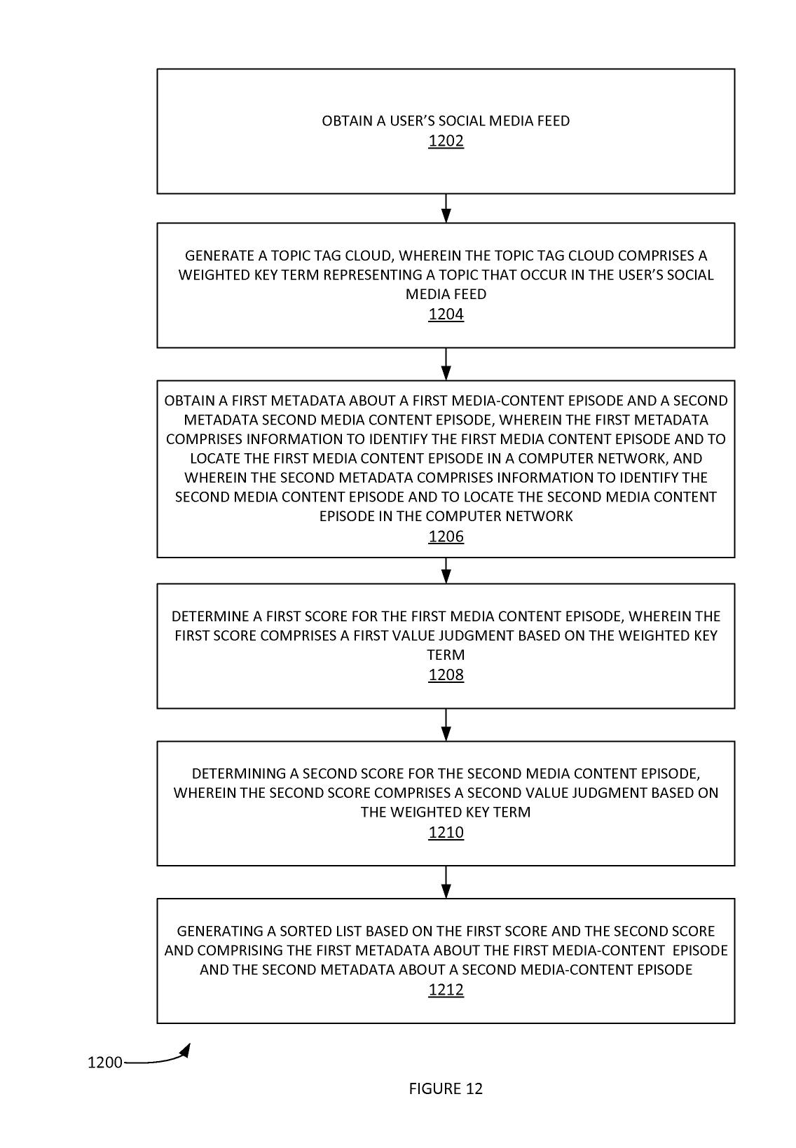

FIG. 12 illustrates another example process 1200 for personalized delivery of media content, according to some embodiments. In step 1202 of process 1200, a user's social media feed can be obtained. In step 1204, a topic tag cloud can be generated. The topic tag cloud can include a weighted key term representing a topic that occur in the user's social media feed. In step 1206, a first metadata about a first media-content episode and a second metadata second media content episode are obtained. The first metadata can include information to identify the first media content episode and to locate the first media content episode in a computer network. The second metadata can include information to identify the second media content episode and to locate the second media content episode in the computer network. In step 1208, a first score for the first media content episode can be calculated. The first score can include a first value judgment based on the weighted key term. In step 1210, a second score for the second media content episode can be calculated. The second score can include a second value judgment based on the weighted key term. In step 1212, a sorted list based on the first score and the second score and including the first metadata about the first media-content episode and the second metadata about a second media-content episode can be generated.

At least some values based on the results of the above-described processes can be saved for subsequent use. Additionally, a (e.g. non-transients) computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) and/or some specialized application-specific language (PHP, Java Script, XML).

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium. Finally, acts in accordance with FIGS. 1-12 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

What is claimed as new and desired to be protected by Letters Patent of the United States is:

1. A system comprising:
a social media tag-cloud generator:
obtaining a user's social media feed, and
generating a topic tag cloud, wherein the topic tag cloud comprises a weighted key term representing a topic that occurs in the user's social media feed;
a media-content source module obtaining a first metadata about a first media-content episode and a second metadata second media-content episode, wherein the first metadata comprises information to identify the first media content episode and to locate the first media content episode in a computer network, and wherein the second metadata comprises information to identify the second media content episode and to locate the second media content episode in the computer network;
a media-content scoring module:
determining a first score for the first media content episode, wherein the first score comprises a first value judgment based on the weighted key term, and
determining a second score for the second media content episode, wherein the second score comprises a second value judgment based on the weighted key term, and
generating a sorted list based on the first score and the second score and comprising the first metadata about the first media content episode and the second metadata about a second media content episode; and
a client management module:
providing the sorted list to a client media-content application operating in a user's computing device, and
receiving a user's skip/consume behavior information with respect to the first media-content episode and the second media-content episode from the client media-content application.

2. The system of claim 1, wherein the first value judgment is based on the weighted key term and a first weighted average judgment based on the user's skip/consume behavior information with respect to the first media-content episode.

3. The system of claim 2, wherein the second value judgment is based on the weighted key term and a second weighted average judgment based on the user's skip/consume behavior information with respect to the second media-content episode.

4. They system of claim 1, wherein the first value judgment is based on the weighted key term, the first weighted average judgment based on the user's skip/consume behavior information with respect to the first media content episode, a first prior by curator score of a first program of the first media content, a first episode delta score of the first media content, and a first user peer score of the first program.

5. The system of claim 4, wherein the second value judgment is based on the weighted key term, the second weighted average judgment based on the user's skip/consume behavior information with respect to the second media content episode, a second prior by curator score of a second program of the second media content, a second episode delta score of the second media content, and a second user peer score of the second program.

6. The system of claim 5, wherein a prior by curator score is assigned by a system administrator.

7. The system of claim 5, wherein an episode delta score is based on a collaborative filtering process that obtains a difference between an expected score for a specified media content determined for a plurality of other users and an actual weighted average judgment score based on the other users' skip/consume behavior information with respect to the specified media content.

8. The system of claim 5, wherein a user peer score is based on applying a collaborative filtering algorithm to a set of peer users of the user, wherein the user peer score is based on the set of peer users' skip/consume behavior information with respect to a specified media-content program.

9. The system of claim 1, wherein the first media content comprises an audio file of a news episode.

10. The system of claim 1, wherein the social media tag-cloud generator navigates a hyperlink located in the user's social media feed to an article available via the Internet, wherein the social media tag-cloud generator creates a topic tag cloud based on a content of the article, wherein each topic is associated with a separate topic tag cloud, wherein a weight for the weighted key term associated with the topic is generated by intersecting the topic tag cloud with a feed tag cloud.

11. The system of claim 10, wherein the weight of the weighted key term equals a topic tag cloud value multiplied by a social media feeds tag cloud value for the topic plus a user's skip/consume weighted judgment for the topic.

12. The system of claim 1, wherein the user's social media feed comprises a social networking service microblog feed managed by the user.

13. A method comprising:
obtaining a user's social media feed;
generating a topic tag cloud, wherein the topic tag cloud comprises a weighted key term representing a topic that occur in the user's social media feed;
obtaining a first metadata about a first media-content episode and a second metadata second media content episode, wherein the first metadata comprises information to identify the first media content episode and to locate the first media content episode in a computer network, and wherein the second metadata comprises information to identify the second media content episode and to locate the second media content episode in the computer network;
determining a first score for the first media content episode, wherein the first score comprises a first value judgment based on the weighted key term;
determining a second score for the second media content episode, wherein the second score comprises a second value judgment based on the weighted key term; and
generating a sorted list based on the first score and the second score and comprising the first metadata about the first media-content episode and the second metadata about a second media-content episode.

14. The method of claim 13 further comprising:
providing the sorted list to a client media-content application operating in a user's computing device.

15. The method of claim 14 further comprising:
receiving a user's skip/consume behavior information with respect to the first media-content episode and the second media-content episode from the client media-content application.

16. The method of claim 15, wherein the first value judgment is based on the weighted key term, the first weighted average judgment based on the user's skip/consume behavior information with respect to the first media content episode, a first prior by curator score of a first program of the first media content, a first episode delta score of the first media content, and a first user peer score of the first program.

17. The method of claim 16, wherein the second value judgment is based on the weighted key term, the second weighted average judgment based on the user's skip/consume behavior information with respect to the second media content episode, a second prior by curator score of a second program of the second media content, a second episode delta score of the second media content, and a second user peer score of the second program.

18. A method comprising:
receiving a user's skip/consume time spent data with respect to a set of consumed media-content episodes, wherein the user's skip/consume time spent data is received from a client media-content application in a user's mobile device, and wherein a media-content episode is associated with a media-content program and a media-content topic;
receiving a set of unconsumed media content episodes;
scoring, with at least one processor, a set of media-content programs and a set of media-content topics associated with the set of consumed media-content episodes based on the user's skip/consume time spent data with respect to each member of the set of consumed media-content episodes; and
sorting the set of unconsumed media-content episodes according to a score of the set of media-content programs and the set of media-content topics.

19. The method of claim 18, further comprising:
providing a set of pointers for each member of the sorted set of unconsumed media-content episodes to the client media-content application in the user's mobile device.

20. The method of claim 18, wherein the user's skip/consume time spent data comprises a time a user consumed each member of the set of consumed media-content episodes relative to each member's total time.
